(19) United States
(12) Patent Application Publication
(10) Pub. No.: US 2013/0098549 A1
(43) Pub. Date: Apr. 25, 2013

(54) PROTECTIVE FILM COVERING AN ELECTRONIC DEVICE WHICH CAN BE APPLIED WET OR DRY

(71) Applicants: Justin Drage, West Jordan, UT (US); William Nelson, Cottonwood Heights, UT (US)

(72) Inventors: Justin Drage, West Jordan, UT (US); William Nelson, Cottonwood Heights, UT (US)

(73) Assignee: Invisible Gadget Guard, Inc., Salt Lake City, UT (US)

(21) Appl. No.: 13/277,068

(22) Filed: Oct. 19, 2011

(51) Int. Cl. B65D 69/00; B32B 37/14; C08G 18/32; C09J 7/02; B32B 27/40; B32B 3/08; B32B 37/12; B32B 3/10

(52) U.S. Cl. 156/308.6; 428/195.1; 428/343; 428/220; 428/189; 206/232; 15/245; 528/85

(57) ABSTRACT

A protective film that can be applied using a wet or dry application process. The protective film may be part of a protective film application kit that also includes a package and, optionally, liquid, installation tabs, and a squeegee.

### BACKGROUND

Portable electronic devices have become virtually indispensible to a large segment of the population. These devices allow users to store and play music, take and view pictures, send and receive email, manage appointments, navigate, access the Internet, and a host of other things. Recent advances have made these devices much more powerful and useful to a wider user base.

Examples of popular portable electronic devices include mobile phones, smartphones and tablets that run Apple's iOS and Google's Android operating systems, digital music players, satellite radios, in-vehicle displays, still and/or video cameras, laptops, navigation devices, and so forth.

The portable nature of these devices means that they are subject to a significant amount of wear over their useful lifetime. They are constantly being put into and taken out of cases, bags, purses, clothing pockets, and so forth. These movements slowly wear on the exterior surface of these devices. In some cases, areas that experience a high degree of wear, such as corners, may change color or texture or otherwise become less visually pleasing. The devices may also be damaged due to one-time events such as accidentally dropping the device or causing it to contact a sharp object such as car keys.

In many cases, the wear only affects the appearance of the device and not its function. Although the device may function properly, its appearance may make it look like it has been used heavily and is on the verge of failure. This dramatically reduces the user's overall satisfaction not to mention the resale value of the device. Most users prefer to use a device that appears and functions like new even though it is not.

A number of products have been developed to protect portable electronic devices. One product is a protective film that adheres to one or more outer surfaces of the device. The protective film is a polymeric material that prevents wear, scratches, and the like. The film is removable so that the device can be restored back to an almost new condition at any time.

There are two types of protective films—Met application films and dry application films. Wet application films are the most common and provide the best results. The wet application method includes a step of applying liquid to the electronic device and/or protective film. The liquid makes it easier to correctly position the film and remove air bubbles, creases, and other imperfections.

Unfortunately, many users are hesitant to expose their expensive and often essential electronic devices to a liquid, even though the manufacturer and other users state that it doesn't do any damage. They would rather leave the device unprotected. This resistance on the part of users has significantly reduced the adoption of wet application protective films.

Dry application protective films are provided for those users who refuse to apply a liquid to their electronic devices. As their name suggests, dry application films are applied without the use of a liquid. The application is similar to the process of applying a sticker to a surface. Without liquid, the dry application films are more susceptible to air bubbles, creases, and other imperfections.

The use of two different types of protective films causes a number of problems. It increases user confusion at the point of sale. Many users don't realize that there are two types of protective films based on how they are applied. The user simply purchases the first “protective film” product that looks suitable only to realize later that it requires a wet or dry application process.

It also increases the overall cost to sell and market the protective films. Retailers are required to stock both wet and dry application protective films to satisfy user's different levels of apprehension about applying a liquid to their electronic devices. This increases inventory requirements and, consequently, the overall cost of the protective films. Retailers are also required to educate users through marketing channels about the differences between the different types of protective films. This also increases the overall cost.

### SUMMARY

A number of representative embodiments are provided to illustrate the various features, characteristics, and advantages of the disclosed subject matter. The embodiments are provided primarily in the context of a protective film for a smartphone. It should be understood, however, that many of the concepts may be used in a variety of other settings, situations, and configurations. For example, the features, characteristics, advantages, etc., of one embodiment can be used alone or in various combinations and sub-combinations with one another.

A protective film for electronic devices can be applied using a wet or dry application process, which is in contrast to conventional protective films that must be applied using one or the other process. The ability to apply the film using either process provides a number of advantages.

One major advantage is realized in the form of lower sales and marketing costs. It is no longer necessary to stock two different types of protective films based on whether the user wants to apply it wet or dry. Also, consumers do not need to be educated about the differences between the two types of protective films. All of these things simplify distribution and sales of the protective films thereby reducing their cost and increasing adoption rates.

Another major advantage is realized by consumers. Whenever a consumer decides to purchase a protective film, the consumer must invest a significant amount of time and effort into figuring out which one to purchase. This includes weighing the pros and cons of wet and dry application films until a decision is reached.

Some consumers may be willing to use either application process, but want to know which film provides the best final appearance. These consumers must research the different protective films to answer this question or risk making a purchase that they later regret.

When faced with the daunting task of doing this pre-purchase investigation, some consumers simply forgo buying a protective film at all. Although it would be nice, it isn't worth the hassle to them. With a single protective film that can be applied both ways, consumers can avoid all of this frustration.

In one embodiment, the protective film is included as part of a protective film application kit that includes all of the components to allow the user to apply the protective film wet or dry. For example, the kit can include the protective film, a squeegee, a container of liquid, a cleaning cloth (e.g., microfiber cloth), and/or installation tabs.

The protective film application kit can also include instructions for applying the protective film using the wet or dry application process. The instructions may be printed on the package or provided as a separate insert. The instructions may also be provided as a link to a website.

The Summary is provided to introduce a selection of concepts in a simplified form that are further described below in the Detailed Description. The Summary and the Background are not intended to identify key concepts or essential aspects of the disclosed subject matter, nor should they be used to constrict or limit the scope of the claims. For example, the scope of the claims should not be limited based on whether the recited subject matter includes any or all aspects noted in the Summary and/or addresses any of the issues noted in the Background.

### DRAWINGS

The preferred and other embodiments are disclosed in association with the accompanying drawings in which:

FIG. 1 is a perspective, exploded view of a smartphone and a protective film that covers the front and back of the smartphone.

FIG. 2 is a perspective, exploded view of a tablet computer and a protective film that covers the front, back, and sides of the tablet.

FIGS. 3-8 show the wet application method for applying the protective film to a smartphone.

FIG. 3 shows the user cleaning the surface of the electronic device.

FIG. 4 shows the user wetting his/her hand.

FIG. 5 shows the user peeling the protective film away from the paper backing.

FIG. 6 shows the user wetting the inside surface of the protective film.

FIG. 7 shows the protective film after it is initially applied to the electronic device.

FIG. 8 shows the user removing the bubbles between the protective film and the electronic device with a squeegee.

FIGS. 9-16 show the dry application method for applying the protective film to a smartphone.

FIG. 9 shows a user peeling an installation tab away from the paper backing.

FIG. 10 shows the user applying the installation tab to the outer surface of the protective film at one end.

FIG. 11 shows the user applying another installation tab to the outer surface of the protective film at the opposite end.

FIG. 12 shows the user peeling the protective film away from the paper backing.

FIG. 13 shows the user applying one end of the protective film to the outer surface of an electronic device.

FIG. 14 shows the user progressively pressing the protective film against the outer surface of the electronic device in a manner that eliminates bubbles and other imperfections.

FIG. 15 shows the user removing the installation tabs from the protective film.

FIG. 16 shows the user further smoothing the protective film to eliminate any remaining bubbles and imperfections.

FIG. 17 shows a protective film application kit that includes instructions for applying the protective film using a wet or a dry application method.

### DETAILED DESCRIPTION

A protective film is disclosed that can be applied using a wet application process or a dry application process. The user is provided with instructions for applying the protective film both ways so that the user can choose the installation method that the user is most comfortable with.

Multiple protective films may be used to cover different surfaces of an electronic device. One protective film may be used to cover the front surface of the device and another protective film to cover the back surface. Additional protective films may be used to cover the sides and other surfaces. Each protective film is shaped to fit the surface of the particular electronic device.

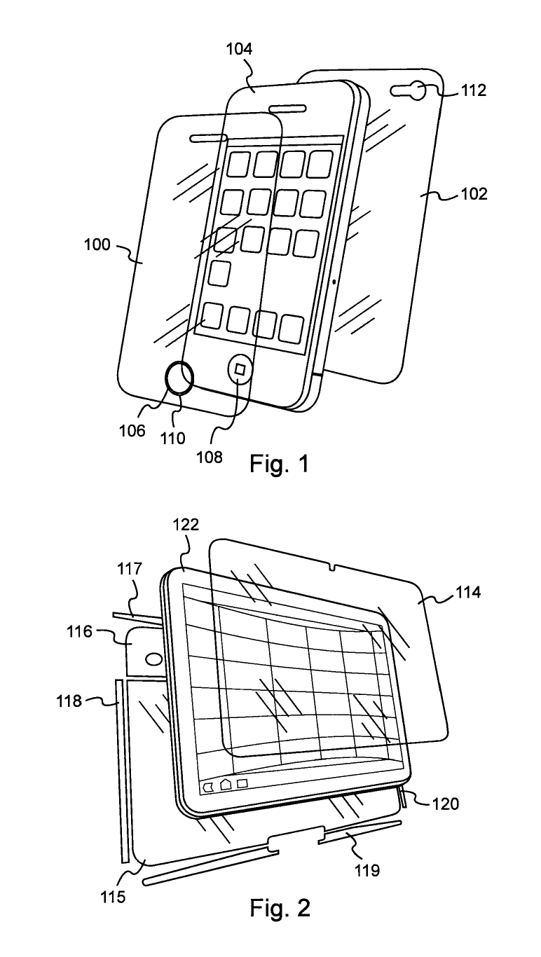

Turning to FIG. 1, protective films 100, 102 are configured to protect the front and back surfaces of a smartphone 104, respectively. The protective film 100 is cut so that an opening 106 is provided for button 108. A separate protective film 110 is provided to cover the button 108. The protective film 102 includes an opening 112 for a rear camera and flash.

The protective film 100 covers the front of the smartphone 104, including its capacitive touch screen. However, the protective film 100 doesn't interfere with the user's ability to interact with and control the smartphone 104. The smartphone 104 recognizes the user's touch and finger gestures just the same as if the protective film 100 wasn't there.

The smartphone 104 in FIG. 1 is the Apple iPhone 4. It should be appreciated that the smartphone 104 is provided to illustrate the one of many different electronic devices that can be protected with the protective film disclosed herein and should not be considered limiting in any way.

FIG. 2 shows a more complex example of a tablet computer 122 that can be protected with multiple protective films 114-120. In this case, the geometry of the table computer 122 makes it necessary to use multiple protective films 114-120. The tablet computer 122 is the Motorola Xoom.

The protective film can have any suitable level of opaqueness and/or any suitable artistic designs on it. The protective film that is applied over the screen or user interface of the electronic device is almost always optically transparent. This prevents it from impeding the user's ability to see the screen.

The protective films applied to other areas of the electronic device can also be optically transparent, but may also have a variety of artistic designs on them. The optically transparent films allow the user to protect the electronic device without substantially changing its appearance. The films with designs allow the user to modify the phone's aesthetics to better match the user's individual tastes and personality.

The protective film can be made from any suitable material such as a polymeric material. In one embodiment, the protective film includes a main layer and an adhesive layer. The main layer can include a relatively clear resin such as a silicone elastomer. The adhesive is provided to hold the protective film to the surface of the electronic device and can be used with either a wet or dry application process.

In one embodiment, the adhesive layer includes a pressure-sensitive adhesive. As the name suggests, pressure sensitive adhesives are designed to form a bond when pressure is applied to the adhesive and the underlying surface. Desirably, the pressure-sensitive adhesive can also adhere to electronic devices when applied using a wet application process.

In one embodiment, the protective film includes a top layer that is especially impervious to scratching and other damage and that also provides a desirable shiny look. The top layer can be a separate layer of material that is stiffer than the underlying the main layer or, preferably, it can be a layer of stiffer material that has been infused into the main layer. In one embodiment, the top layer includes polyurethane.

One example of a suitable material for the protective film is the EST-208 (8 mil) non-coated Nano-Fusion material supplied by Avery Dennison. Additional protective film embodiments are disclosed in U.S. Patent Application Publication Number 2008/0286576, titled “Protective Sheets, Articles, and Methods,” filed on 23 Oct. 2006, and which is incorporated by reference herein in its entirety.

The protective film can be any suitable thickness. For example, the thickness can be no more than 12 mils or no more than 10 mils. The thickness can also be approximately 2 mils to approximately 10 mils or approximately 4 mils to approximately 9 mils. Preferably, the thickness of the protective film is approximately 6 mils to approximately 8 mils. The thickness of the adhesive layer can be approximately 1 mil to 4 mils with the main layer making up the rest of the thickness.

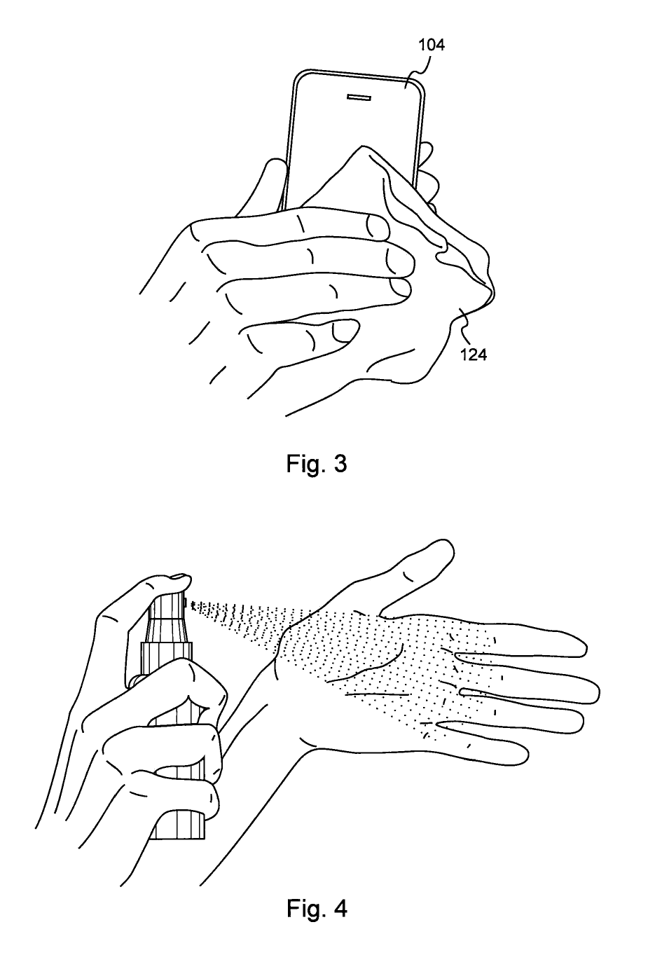

FIGS. 3-8 show how to apply the protective film 100 to the smartphone 104 using a wet application process. The first step in the process is to turn off the smartphone 104 and remove the battery. This is done as a precaution to prevent the internal electronics of the smartphone 104 from shorting if too much liquid is accidentally applied.

The next step in the process is to clean the surface of the smartphone 104. FIG. 3 shows a user cleaning the front surface of the smartphone 104 with a cloth 124. This is typically performed by applying a cleaning liquid such as water to the surface of the smartphone 104 and wiping away any foreign matter with the cloth 124.

Any suitable wipe or cloth 124 may be used to clean the electronic device. One cloth that works well is a microfiber cloth. The microfiber cloth readily absorbs the liquid and any foreign matter that is present on the smartphone 104.

The user wets his or her hands as shown in FIG. 4. The user should keep his or her hands wet throughout the application process to prevent fingerprints from getting on the inside surface of the protective film or the surface of the smartphone 104.

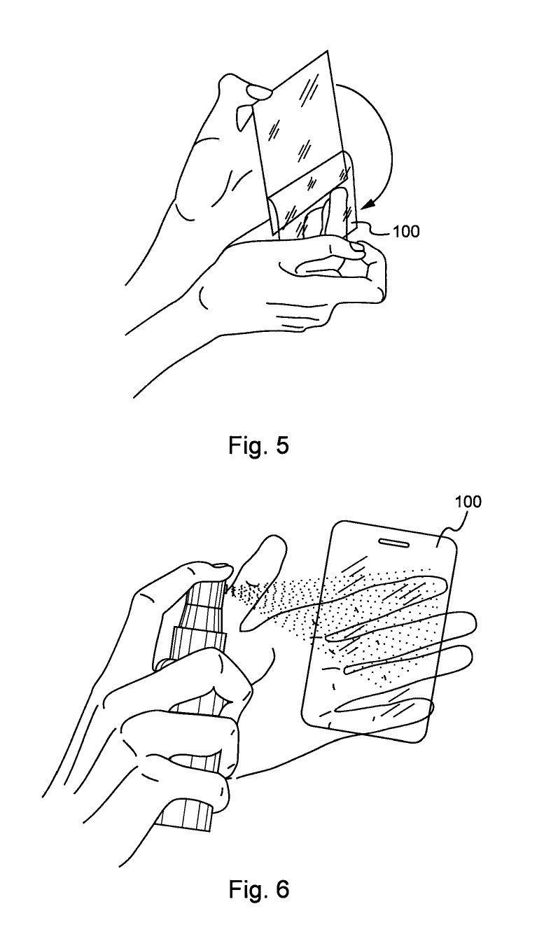

The protective film 100 is removed from the paper backing and wetted as shown in FIGS. 5-6. The liquid keeps the protective film 100 from sticking too quickly to the smartphone 104 thereby allowing the user sufficient time to correctly position the protective film 100. A small amount of liquid is all that is needed. The liquid is preferably water, but can also be a mixture of water and alcohol, water and dish soap, and the like.

The protective film 100 is placed on the smartphone 104 and aligned to match its front surface. The liquid allows the protective film 100 to slide on the surface of the smartphone 104.

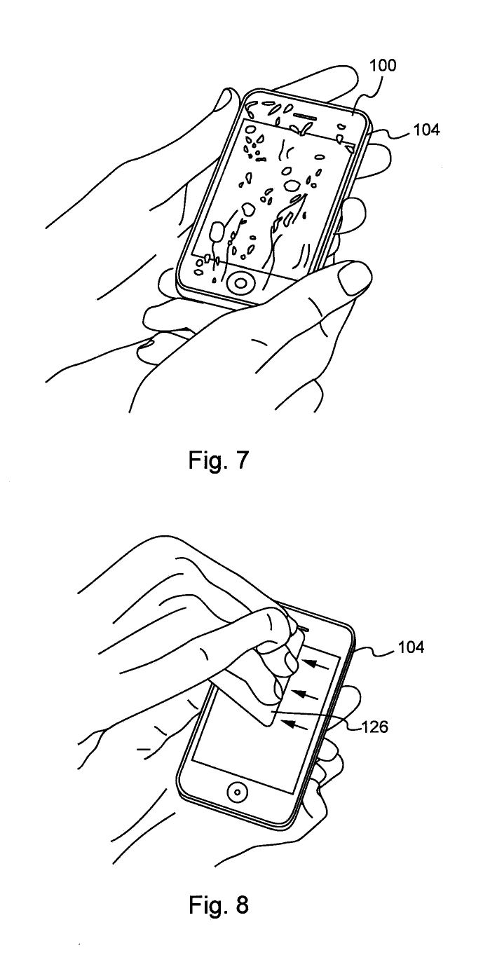

Once the protective film is properly in place, there are still multiple air pockets between the protective film 100 and the front surface of the smartphone 104 as shown in FIG. 7. The air pockets and any excess liquid are removed using a squeegee 126 as shown in FIG. 8.

The squeegee 126 should move from the center of the protective film 100 to the edges to force the excess liquid and air out. Excess liquid should not be allowed to enter openings in the smartphone 104 such as those for the speaker or microphone.

It may take up to 24-48 hours for the protective film 100 to completely cure. Curing can be accelerated using low heat, such as a blow dryer or the interior of a parked car on a warm day, as long as care is taken to prevent the protective film from getting too hot. During the drying process, the protective film 100 strongly adheres to the front surface of the smartphone 104.

In some situations, the corners and edges of the protective film 100 may not stay down. This can be fixed by waiting 5-10 minutes and then pressing the corners and edges down when the adhesive is more tacky.

The smartphone 104 is now ready for everyday use without worrying about wear and tear. The protective film 100 can be removed at any time to restore the smartphone 104 to an almost new condition.

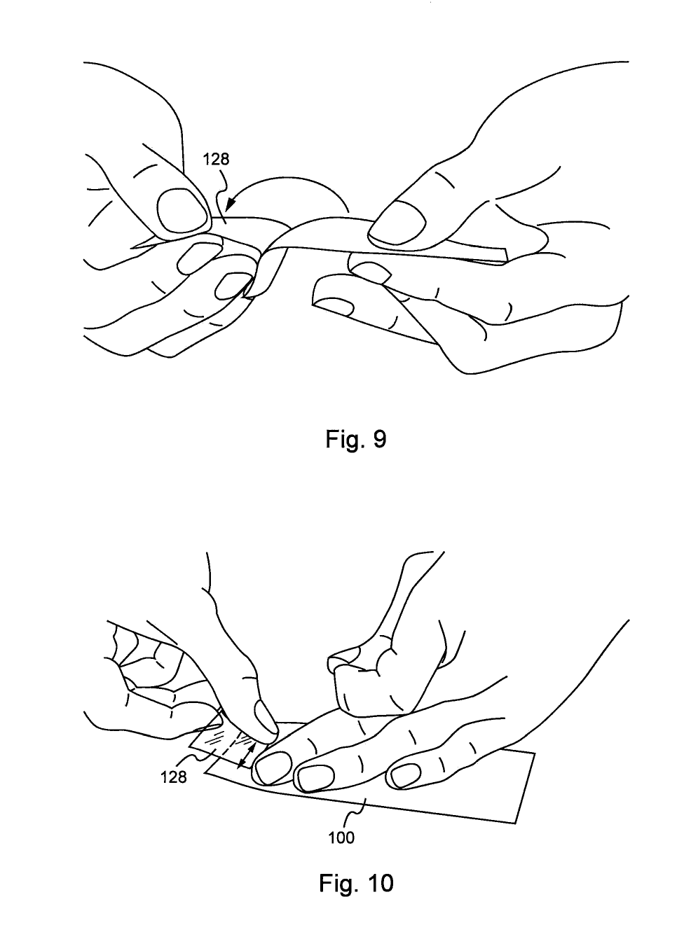

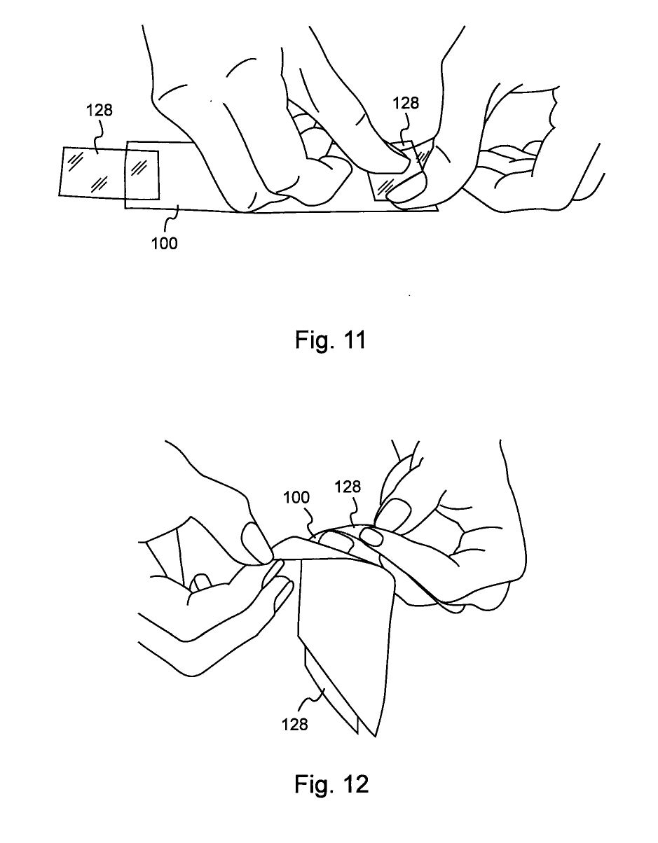

FIGS. 9-16 show how to apply the same protective film 100 to the smartphone 104 using a dry application process. The first step in the process is to prepare the smartphone 104 by cleaning in the same way described above.

In this embodiment, the dry application process uses two installation tabs 128 to assist with correctly positioning the protective film 100 on the smartphone 104. The installation tabs 128 are each removed from the paper backing and positioned at opposite ends of the protective film 100 as shown in FIGS. 9-11. Only about half of the installation tabs 128 are stuck to the protective film 100 and the rest extends outward beyond it so the user can grip them.

The installation tabs 128 are applied to the protective film 100 with the paper backing still on the protective film 100. Once the installation tabs 128 are in place, the paper backing is removed as shown in FIG. 12. Care should be taken not to touch the adhesive side of the protective film 100.

The protective film 100 is aligned with the front surface of the smartphone 104 using the installation tabs 128 as handles. The protective film 100 should not contact the smartphone 104 during the alignment process. Any openings in protective film 100 should be carefully aligned with the corresponding feature of the smartphone 104.

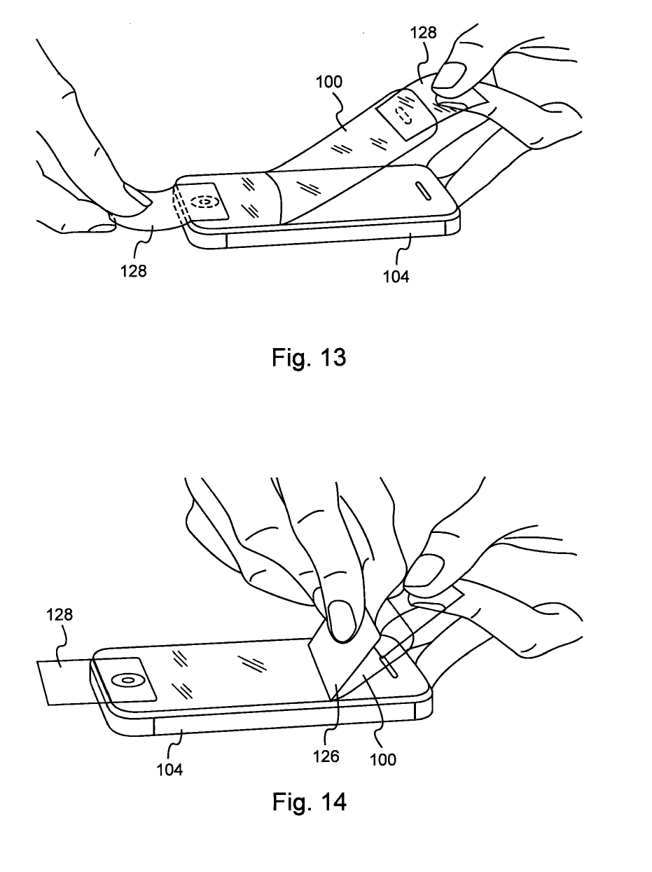

Once the protective film 100 is properly aligned, one side of the protective film is pressed down onto the smartphone 104 while the other side remains elevated as shown in FIG. 13. The squeegee 126 is used to slowly and progressively press the rest of the protective film 100 down as shown in FIG. 14. The squeegee 126 moves from one side of the protective film 100 to the other to minimize the formation of air pockets.

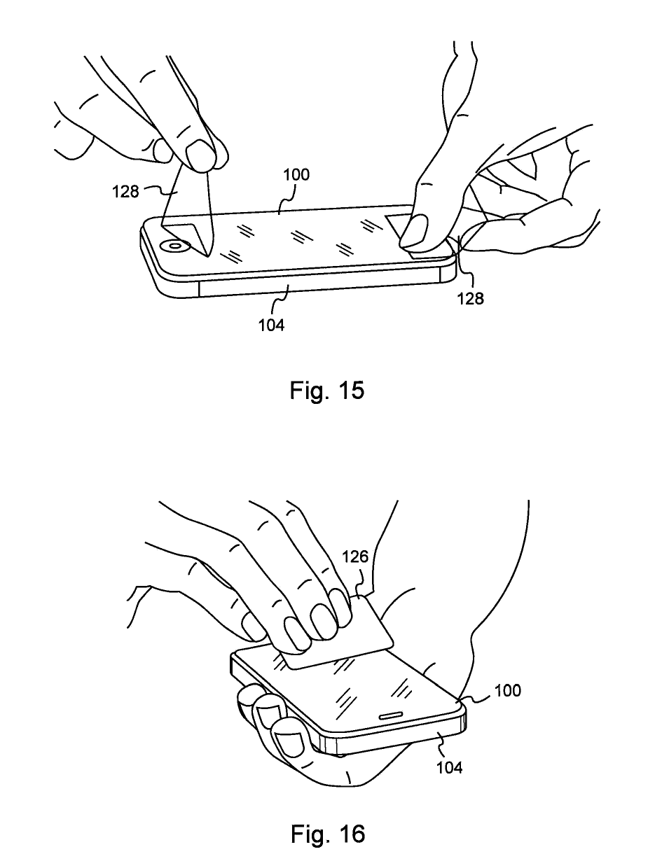

If the protective film 100 was not properly aligned, it can be removed using the installation tabs 128 and repositioned using the procedure just described. Once the protective film 100 is positioned correctly, the installation tabs 128 are removed by holding down the surrounding area and carefully peeling them off as shown in FIG. 15.

The squeegee 126 is used to remove any remaining air pockets between the protective film 100 and the smartphone 104. This is done by firmly pressing down on the squeegee 126 and moving it across the protective film 100 as shown in FIG. 16. The squeegee 126 should move from the center of the protective film 100 outward.

The smartphone 100 is ready to use immediately. Any remaining micro-bubbles typically disappear within 24-48 hours of installation.

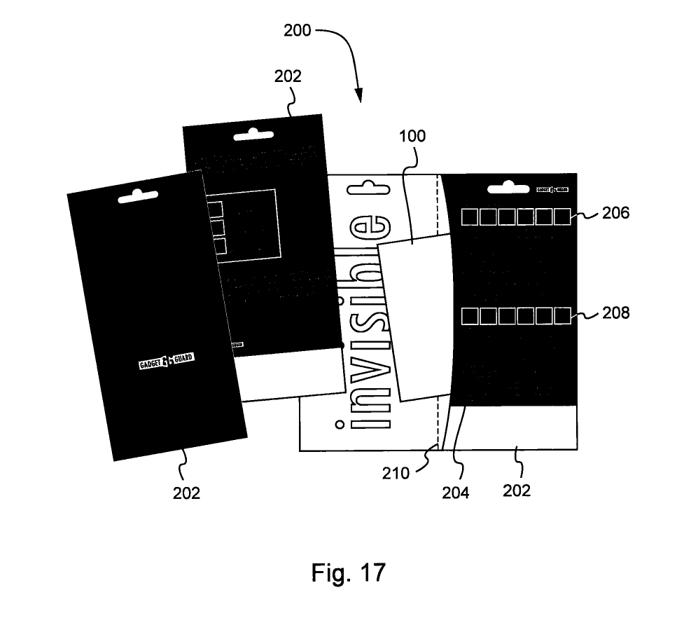

The protective film 100 can be included as part of a protective film application kit 200 as shown in FIG. 17. In addition to the protective film 100, the protective film application kit 200 may include a package 202, the cloth 124, the squeegee 126, the installation tabs 128, and/or a small container of liquid such as that shown in FIG. 6 only miniaturized.

The package 202 can have any suitable configuration. The leftmost image in FIG. 17 shows the front side of the package 202 and the next image shows the back side of the package 202. The rightmost image shows the package 202 unfolded with part of the protective film 100 in the package pocket 204.

The package 202 folds along line 210 to keep the protective film 100 in the pocket 204 until the user opens it. Typically, the package 202 includes all of the protective films used to protect a single device along with the other items mentioned above.

The package 202 also includes instructions to apply the protective film using a wet or dry application process. As shown in FIG. 17, the package 202 includes first instructions 206 for applying the protective film 100 to the surface of an electronic device with a liquid and second instructions 208 for applying the protective film 100 without using a liquid. For example, the instructions 206, 208 may explain the steps described above to apply the protective film using the wet or dry application process.

In FIG. 17, the instructions 206, 208 are printed on the surface of the pocket 204. However, it should be appreciated that the instructions could also be provided in the form of a separate insert or as a URL to a webpage. The package 202 also includes information informing the user that the protective film can be applied using a wet or dry application process.

### Illustrative Embodiments

Reference is made in the following to a number of illustrative embodiments of the disclosed subject matter. The following embodiments illustrate only a few selected embodiments that may include one or more of the various features, characteristics, and advantages of the disclosed subject matter. Accordingly, the following embodiments should not be considered as being comprehensive of all of the possible embodiments.

The concepts and aspects of one embodiment may apply equally to one or more other embodiments or may be used in combination with any of the concepts and aspects from the other embodiments. Any combination of any of the disclosed subject matter is contemplated.

In one embodiment, a protective film application kit comprises: a package including a protective film configured to cover at least one surface of an electronic device; first instructions to apply the protective film to the at least one surface of the electronic device using a liquid; and second instructions to apply the protective film to the at least one surface of the electronic device without using a liquid.

The package may include a pocket that holds the protective film. The package may include a front side and a back side and a fold between the front side and the back side. The protective film may be optically transparent or it may include an ornamental design that changes the appearance of the electronic device when the protective film is applied to the electronic device.

The protective film may include a polymeric layer and an adhesive layer. The polymeric layer may include thermoplastic urethane. The thickness of the protective film may be no more than approximately 12 mils or approximately 2 mils to approximately 10 mils.

The first instructions and the second instructions may be on the package, e.g., printed on the package, or they may be provided on a separate insert included with the package. The first instructions and the second instructions may be separate from each other, e.g., provided as standalone instruction sets.

The protective film application kit may comprise a liquid configured to wet the protective film when the protective film is applied to the electronic device. The first instructions may explain how to use the liquid to apply the protective film to the electronic device.

The protective film application kit may comprise an installation tab configured to removably adhere to the protective film when the protective film is applied to the electronic device. The second instructions may explain how to use the installation tab to apply the protective film to the electronic device. The protective film application kit may also comprise a squeegee.

In another embodiment, a method for applying a protective film to an electronic device comprises: providing a protective film that is configured to cover at least one surface of the electronic device; providing first instructions to apply the protective film to the at least one surface of the electronic device using a liquid; and providing second instructions to apply the protective film to the at least one surface of the electronic device without using a liquid.

The method may comprise applying the protective film to the at least one surface of the electronic device by following the first instructions or the second instructions. The protective film may include a main layer and an adhesive layer.

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure the term shall mean,” etc.).

References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. The subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be given their broadest interpretation in view of the prior art and the meaning of the claim terms.

As used herein, spatial or directional terms, such as “left,” “right,” “front,” “back,” and the like, relate to the subject matter as it is shown in the drawings. However, it is to be understood that the described subject matter may assume various alternative orientations and, accordingly, such terms are not to be considered as limiting.

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y). The term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

All ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. A protective film application kit comprising:
a package including
a protective film configured to cover at least one surface of an electronic device;
first instructions to apply the protective film to the at least one surface of the electronic device using a liquid; and
second instructions to apply the protective film to the at least one surface of the electronic device without using a liquid.

2. The protective film application kit of claim 1 wherein the package includes a pocket that holds the protective film.

3. The protective film application kit of claim 1 wherein the package includes a front side and a back side and a fold between the front side and the back side.

4. The protective film application kit of claim 1 wherein the protective film is optically transparent.

5. The protective film application kit of claim 1 wherein the protective film includes an ornamental design that changes the appearance of the electronic device when the protective film is applied to the electronic device.

6. The protective film application kit of claim 1 wherein the protective film includes a polymeric layer and an adhesive layer.

7. The protective film application kit of claim 6 wherein the polymeric layer includes thermoplastic urethane.

8. The protective film application kit of claim 1 wherein the thickness of the protective film is no more than approximately 12 mils.

9. The protective film application kit of claim 1 wherein the thickness of the protective film is approximately 2 mils to approximately 10 mils.

10. The protective film application kit of claim 1 wherein the first instructions and the second instructions are on the package.

11. The protective film application kit of claim 1 wherein the first instructions and the second instructions are on a separate insert included with the package.

12. The protective film application kit of claim 1 wherein the first instructions and the second instructions are separate from each other.

13. The protective film application kit of claim 1 comprising a liquid configured to wet the protective film when the protective film is applied to the electronic device.

14. The protective film application kit of claim 13 wherein the first instructions explain how to use the liquid to apply the protective film to the electronic device.

15. The protective film application kit of claim 1 comprising an installation tab configured to removably adhere to the protective film when the protective film is applied to the electronic device.

16. The protective film application kit of claim 15 wherein the second instructions explain how to use the installation tab to apply the protective film to the electronic device.

17. The protective film application kit of claim 1 comprising a squeegee.

18. A method for applying a protective film to an electronic device comprising:
applying moisture to the protective film and/or the electronic device, wherein the protective film includes a pressure-sensitive adhesive; and
applying the protective film to the electronic device.

19. The method of claim 18 wherein the protective film includes a polyurethane layer.

20. The method of claim 18 wherein the protective film includes a top layer, a main layer, and an adhesive layer, and wherein the adhesive layer includes the pressure-sensitive adhesive.
